(19) United States
(12) Patent Application Publication
(10) Pub. No.: US 2026/0081750 A1
(43) Pub. Date: Mar. 19, 2026

(54) FULLY HOMOMORPHIC ENCRYPTED PROCESSING ACCELERATION

(71) Applicant: Niobium Microsystems, Inc., Dayton, OH (US)

(72) Inventors: Georgios Dimou, Dayton, OH (US); David A. Archer, Dayton, OH (US); Brian Huffman, Dayton, OH (US); Tynan McAuley, Dayton, OH (US); Michiel Van Beirendonck, Viaams-Brabant (BE)

(73) Assignee: Niobium Microsystems, Inc., Dayton, OH (US)

(21) Appl. No.: 19/396,144

(22) Filed: Nov. 20, 2025

Related U.S. Application Data
(63) Continuation-in-part of application No. 18/674,852, filed on May 25, 2024.
(63) Continuation-in-part of application No. 18/674,853, filed on May 25, 2024.
(63) Continuation-in-part of application No. 18/674,854, filed on May 25, 2024.
(63) Continuation-in-part of application No. 18/674,855, filed on May 25, 2024.
(60) Provisional application No. 63/504,625, filed on May 26, 2023.
(60) Provisional application No. 63/504,629, filed on May 26, 2023.
(60) Provisional application No. 63/504,631, filed on May 26, 2023.
(60) Provisional application No. 63/504,620, filed on May 26, 2023.

(51) Int. Cl. H04L 9/00; H04L 9/08

(52) U.S. Cl. CPC H04L 9/008; H04L 9/0869; H04L 9/0891

(57) ABSTRACT

A device for processing homomorphically encrypted data, preferably including a memory, a number-theoretic transform processing element, and/or a multiply-accumulate processing element. The memory can preferably be accessed by row or column through XOR-based address mapping procedures performed at a permutation processing element that preferably converts data between conflict-free memory bank ordering and natural ordering, such as wherein the device can receive input data to be stored in the memory and/or send output data from the memory to a processing board. The multiply-accumulate processing element can preferably perform a key-switching operation using a key-switching key and the input data, wherein a first half of the key-switching key is randomly generated at a random number generator. The multiply-accumulate processing element can include a command input with pipeline stages, a register file, a plurality of multiplexers, a multiplier, and/or an adder.

### CROSS-REFERENCE TO RELATED APPLICATIONS

This application is a continuation-in-part of U.S. patent application Ser. No. 18/674,852, filed 25 May 2024, which claims the benefit of U.S. Provisional Application No. 63/504,625, filed 26 May 2023; is a continuation-in-part of U.S. patent application Ser. No. 18/674,853, filed 25 May 2024, which claims the benefit of U.S. Provisional Application No. 63/504,629, filed 26 May 2023; is a continuation-in-part of U.S. patent application Ser. No. 18/674,854, filed 25 May 2024, which claims the benefit of U.S. Provisional Application No. 63/504,631, filed 26 May 2023; and is a continuation-in-part of U.S. patent application Ser. No. 18/674,855, filed 25 May 2024, which claims the benefit of U.S. Provisional Application No. 63/504,620, filed 26 May 2023; each which is incorporated in its entirety by this reference.

### TECHNICAL FIELD

This invention relates generally to the homomorphic encryption field, and more specifically to a new and useful fully homomorphic encryption accelerator system and method of use in the homomorphic encryption field.

### BACKGROUND OF THE INVENTION

Various aspects of the present invention relate generally to homomorphic encryption and more specifically to hardware accelerators for processing fully homomorphically encrypted data.

Fully Homomorphic Encryption (FHE) provides a simple use model to securely outsource computation on sensitive data to a third party. Basically, an FHE system can process encrypted data without a requirement to unencrypt the data. Therefore, third parties may be able to process sensitive data.

### BRIEF DESCRIPTION OF THE SEVERAL VIEWS OF THE DRAWINGS

FIG. 1 is block diagram illustrating a device (a board) for processing fully homomorphic encrypted (FHE) data using a dedicated FHE accelerator, according to various aspects of the present disclosure.

FIG. 2 is a diagram illustrating a radix-4 NTT element for use in the dedicated FHE accelerator of FIG. 1, according to various aspects of the present disclosure.

FIG. 3 is a diagram showing a radix-16 NTT built using several radix-4 NTTs of FIG. 2, according to various aspects of the present disclosure.

FIG. 4 is a block diagram illustrating a conflict-free memory access, according to various aspects of the present disclosure.

FIG. 5 is a block diagram illustrating a size-four permutation processing elements (PE), according to various aspects of the present disclosure.

FIG. 6 is a block diagram illustrating a size-four permutation processing elements (PE), according to various aspects of the present disclosure.

FIG. 7 is a block diagram of a random number generator, according to various aspects of the present disclosure.

FIG. 8 is a block diagram illustrating a MAC PE unit including a pipeline, according to various aspects of the present disclosure.

### DETAILED DESCRIPTION OF THE INVENTION

Fully Homomorphic Encryption (FHE) provides a simple use model to securely outsource computation on sensitive data to a third party. Informally, the FHE model enables a user to encrypt their data, m, into a ciphertext c=Enc(m), then send it to a third party, who can compute on c. The third party produces another ciphertext c′ encrypting f(m) for some desired function f (i.e., :c′=f(c)=Enc (f(m))). Thus, f was computed homomorphically.

In FHE, the third party receives only ciphertexts and a public key but never a secret key that allows decryption. As a result, sensitive inputs are protected under the security of the encryption scheme. Because the result of the computation remains encrypted, the output also remains unknown to the third party: only the holder of the secret key can decrypt and access it.

To achieve security, the ciphertexts of all FHE schemes are noisy: during encryption, a small noise term is added to the input data. Decryption can still recover the correct result, provided that the noise is small enough. To evaluate a function homomorphically, the function is represented in terms of operations provided by the scheme (typically addition and multiplication) and compute these operations on the encrypted inputs (i.e., there is no decryption when performing the operations). Each operation increases the noise in the resulting ciphertext, so only a limited number of homomorphic operations may be computed before a limit of decryption failure is reached.

Because multiplications increase ciphertext noise much more than additions, noise growth is modeled by a number of sequential multiplications only (i.e., noise from addition operations is ignored). If we compute the product from one to L for all data one to L homomorphically, then the computation requires multiplicative depth [log₂(L)]. This is accomplished by writing the product in a tree structure, with each leaf node representing one of the factors. In general, there is a trade-off between computational cost and tolerating a larger L: FHE parameters may be increased to obtain more multiplicative depth, but in doing so, the homomorphic operations are slower and the size of the ciphertexts is larger.

To support the computation of functions regardless of their multiplicative depth, FHE uses bootstrapping, which reduces noise by decrypting a ciphertext homomorphically. Unfortunately, bootstrapping is very expensive, so its use is often minimized. There are several techniques to slow down the noise growth, which delays bootstrapping. However, bootstrapping and key switching tend to heavily dominate computation and data movement costs of an application: in a simple 1,024-point, 10-feature logistic regression, these tasks account for over 95% of the computational effort and the vast majority of data movement.

As discussed herein, embodiments systems and devices incorporate the homomorphic encryption scheme known as BGV encryption (named after the people who proposed the encryption scheme: Brakerski, Gentry, and Vaikuntanathan). However, other homomorphic encryption schemes (e.g., CKKS (Cheon-Kim-Kim-Son) FHE and others) may be used in other embodiments of the systems and devices discussed herein; BGV is used as an example. Plaintexts and ciphertexts are represented by elements in the ring [symbol] = [symbol] [X]/(X^{N}+1) with N a power of 2. Those elements are thus polynomials reduced modulo X^{N}+1, and this modular reduction is implicit a notation discussed herein. BGV guarantees finite data structures by also reducing the coefficients: the plaintext space is computed modulo t (denoted Rt), and the ciphertext space is a pair of elements modulo q (denoted [symbol] ²_{q}). Reduction modulo m (with m=t or q) is explicitly denoted by [⋅] m. It is always done symmetrically around 0, i.e., in the set [−m/2,m/2)∩ [symbol] .

As with traditional ciphers, BGV has encryption and decryption procedures to move between the plaintext space and the ciphertext space. While these operations are never executed by the device performing outsourced computation, it is necessary to explain the ciphertext format in order to understand homomorphic operations. A BGV ciphertext (c₀, c₁)∈ [symbol] ²_{q} is said to encrypt plaintext m E Rt under secret key s (which has small coefficients) if c₀+c₁·s=m+te (mod q) for some element e that also has small coefficients. The term e is called the noise, and it determines if decryption returns the correct plaintext: as long as e has coefficients roughly smaller than q/2t, the expression m+te does not overflow modulo q. Therefore, the plaintext can be recovered uniquely as m=[c₀+c₁·ₛ]_{q}]ₜ.

It has been observed that for t=p^{r} with p an odd prime, the plaintext space [symbol] ₜ is equivalent to [symbol] for some [symbol] that divides N. This technique is referred to as packing, and it allows us to encode [symbol] numbers into one plaintext simultaneously. Addition and multiplication over tuples in [symbol] are then performed component-wise. As a result, one ciphertext can encrypt and operate on an entire tuple, which leads to significant performance gains and memory reductions in practice.

When BGV is used in conjunction with packing, we can define three basic homomorphic operations. Let (c₀, c₁) and (c′₀, c′₁) be two ciphertexts encrypting the tuples (m₁, . . . , m [symbol] ) and (m′₁, . . . , m′ [symbol] ), then there are the following operations:
Addition: compute ([c₀+c′₀]_{q}, [c₁+c′₁]_{q}). The encrypted plaintext is (m₁+m′₁, . . . , m [symbol] +m′ [symbol] ).
Multiplication: compute ([c₀·c′₀]q, [c₀·c′₁+c₁·c′₀]_{q}, [c₁·c′₁]_{q}). The resulting ciphertext is a vector of three elements, but this can be reduced back to two with a post-processing step called key switching. The encrypted plaintext is (m₁·m′₁, . . . , m [symbol] ·m′ [symbol] ).
Permutation: compute (φₖ(c₀), φₖ(c₁)), where the map φₖ is called an automorphism. It is parameterized by an odd integer k, and defined as φₖ: c(X)→c(Xₖ). These automorphisms induce a permutation on the elements of the encoded tuple, so the output encrypts some permutation of (m₁, . . . , m [symbol] ). Although the resulting ciphertext has only two elements, there is still a need for post-processing by means of key switching.

Basic homomorphic operations (as identified above as addition, multiplication, and permutation) lead to ciphertext expansion and noise growth. Take for example a product ciphertext: it consists of three elements and it is encrypted under (s, s²) instead of s. The same problem occurs during permutation: the automorphism φₖ has a side effect on the secret key, so the resulting ciphertext is encrypted under φₖ(s). Also noise growth is an issue: the noise term in a product ciphertext, for example, has increased to te·e′.

To prevent ciphertext expansion, switch between keys and slow down noise growth, BGV defines two auxiliary procedures:
Modulus switching: given a ciphertext (c₀, c₁)∈ [symbol] ²_{q} and a new modulus q′, compute a ciphertext (c′₀, c′₁)∈ [symbol] ²_{q}′ that decrypts with respect to q′. Modulus switching also scales the noise by a factor of q′/q.
Key switching: given a key switching matrix (vector(k₀), vector(k₁)) and either a product ciphertext (c₀, c₁, c₂)∈ [symbol] ³_{q} or a permuted ciphertext (c₀, c₁)∈ [symbol] ²_{q}, compute a ciphertext (c′₀, c′₁)∈R²_{q} that decrypts under c₀+c₁·s=m+te (mod q). Thus key switching brings the ciphertext back to its original format

In summary, modulus switching is run before each multiplication to reduce the noise to its minimum level. Key switching is run after each permutation or multiplication to keep the ciphertext format consistent.

When the entire noise budget of a ciphertext is consumed (equivalently, when the modulus q is depleted to its minimum value by successive modulus switchings), further homomorphic operations are no longer immediately possible. However, a bootstrapping procedure that reduces the noise back to a lower level may overcome this problem. Bootstrapping “refreshes” a ciphertext by running decryption homomorphically: we first evaluate an adapted version of the c₀+c₁·S=m+te (mod q) equation discussed above, followed by coefficient-wise rounding.

The following table indicates parameter ranges and examples for devices and systems described herein:

| Parameter | Range | Example |
|---|---|---|
| Security parameter | N/A | 128 bits |
| Ring dimension N | 512-65536 | 65536 |
| Plaintext modulus pr | >2 | 127³ |
| Ciphertext packing [symbol] | 2-65536 | 64 slots |
| Max log₂(QP) for key switching | 20-1782 | 1782 bits |
| Max log₂(Q) for ciphertext | 20-1782 | 1263 bits |
| Max multiplicative depth L | N/A | 31 |

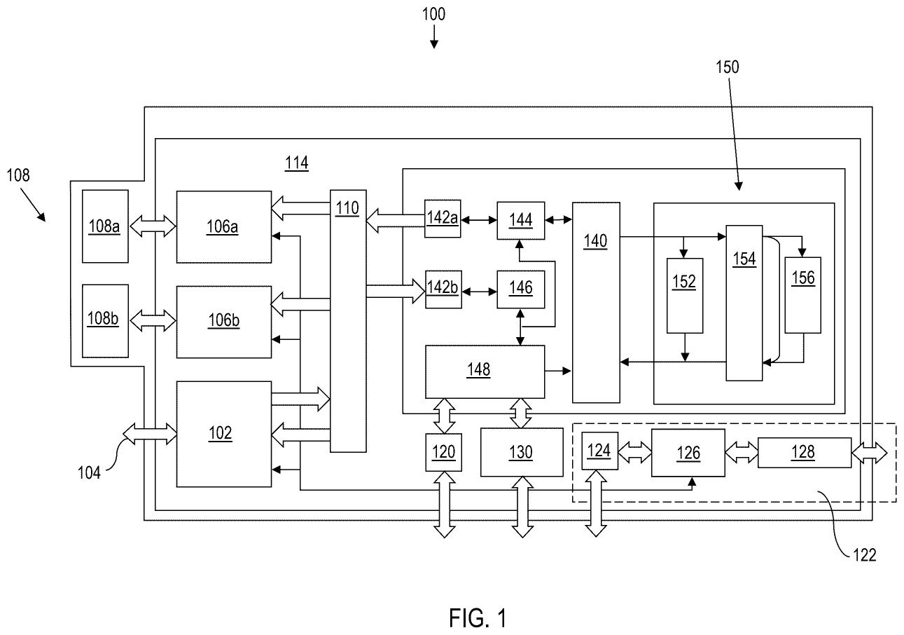

Turning now to the figures and in particular to FIG. 1, a device 100 for executing programs and processing data that have been homomorphically encrypted is shown. In many embodiments, the device 100 is a daughter card or other type of printed circuit board that includes an interface 102 to a host system. The interface 102 can be any high-speed bus structure including, but not limited to, Peripheral Component Interconnect extended (PCI-X), Peripheral Component Interconnect Express (PCIe). Rapid I/O, HyperTransport, etc. As with any interface, the interface 102 of the device 100 includes pins 104 that may be unidirectional data pins, bidirectional data pins, power pins, ground pins, etc., depending on the bus structure associated with the interface 102. Further, in several embodiments, a custom bus structure is used as the interface 102.

In most embodiments, the device further includes a mass memory 108 for storing data. The mass memory 108 may be any reasonable type of memory. For example, the mass memory 108 can be one or more double data-rate (DDR) random access memory (RAM) chips, other RAM chips (dynamic RAM, static RAM, etc.), flash, high-bandwidth memory (HBM), etc.). The mass storage 108 serves as the staging area for data that is scheduled for processing and for results that are ready for retrieval by the host system.

A high-speed interconnect 110 is coupled between the interface 102 and the mass memory 108. The interface 102 receives input data (e.g., homomorphically encrypted data), and memory controllers (e.g., memory access interface 106a, 106b) interface with the memory to store the received data.

In many embodiments, there are two RAM chips 108a, 108b used for the mass memory 108. Twin double-data-rate interfaces allow for a maximized practical throughput by avoiding collisions between the interface-to-mass-storage access stream and the dedicated-fully-homomorphic-encryption-accelerator-to-mass-storage access stream. Each memory chip 108a, 108b will have the corresponding memory access interface 106a, 106b to communicate with the high-speed interconnect 110.

Several embodiments of the device 100 also include a joint test action group (JTAG) interface 120 for debugging the dedicated fully homomorphic encryption accelerator 114 and a configuration system 122 including a configuration JTAG interface 124, a RISC processor 126, and low-speed input/outputs 128. In some embodiments, the device 100 further includes a secondary bus 130 for direct communication with a remote dedicated fully homomorphic encryption accelerator on a similar remote apparatus.

The dedicated fully homomorphic encryption accelerator 114, the JTAG interface 120 for debugging the dedicated fully homomorphic encryption accelerator 114, the configuration system 122 and the secondary bus 130 may all be part of the same application specific integrated circuit (as shown in FIG. 1), may all be discrete chips, or may be spread among two or more chips.

The dedicated fully homomorphic encryption accelerator 114 includes a memory buffer (herein called a ciphertext buffer (CTB)) 140 and several processing elements 150 (discussed below). As will be discussed below, the processing elements 150 may also include memory structures. The CTB 140 should be about three orders of magnitude less than the mass storage 108. For example, if the mass storage includes 256 gigabytes (GB) of memory, then the CTB 140 can be about 64-256 megabytes (MB). However, the CTB 140 should be considerably faster; for example a round-trip latency for the mass storage can be over 100 nanoseconds (ns) while the round-trip latency for the CTB 140 should be about 3 ns.

As an example, the CTB 140 includes 64 MB. In such a CTB 140, there are 2²⁴ (˜16 million) locations, each of which holds a 32-bit (doubleword (dword)) residue polynomial coefficient for use in processing the encrypted data. Continuing with the example, a single residue polynomial includes N=2¹⁶=64K coefficients and occupies one entire page of the CTB 140. For smaller ring dimensions, a single CTB page will include multiple residue polynomials. In some embodiments, the CTB 140 is a single-port SRAM (static random access memory) array that can either read or write 2048 32-bit residue polynomial coefficients every machine cycle, providing a total bandwidth of 8 Tb/s (Terabit per second) (at 1 GHz operation) to the Processing Elements (PEs) 140 (discussed below).

Data-dependent control flow such as branching and iteration does not exist in FHE since variables are encrypted. As an advantage of this determinism, allocation and size of all data and operands are bound at compile-time. This allows the CTB 140 to be structured as an addressable set of ciphertext registers, instead of requiring the complex functionality of a run-time cache memory. This set of registers is compiler-managed with a true Least-Recently Used (LRU) replacement policy. In some embodiments, values that are known not to be used again will be retired. CTB 140 bandwidth is not materially affected by concurrent transfer between the mass memory 108 and the CTB 140: roughly at most 0.3% of CTB 140 access cycles are used by the mass memory 108 bandwidth. In other words, access to the CTB is predominantly local.

For many applications, the CTB 140 is too small (e.g., 64 MB) to hold sizeable working sets of ciphertexts and key switching matrices. As such, the mass memory 108 ensures that CTB 140 capacity misses do not have to spill to memory of the host system.

The dedicated FHE includes memory access interfaces 142a, 142b, a direct memory access (DMA) structure 144, an instruction queue 146, as well as a traffic control unit 148.

As mentioned above, the dedicated fully homomorphic encryption (FHE) accelerator 114 also includes processing elements (PEs) 150. There are three basic types of PEs in the dedicated FHE accelerator 114: Multiply-Accumulate (MAC) PES 152, Permutation PEs 154, and NTT (Number-Theoretic Transform) PEs 156. Multiple PEs 150 work in parallel to quickly perform operations on the encrypted data using at least four types of parallelism: (i) over multiple ciphertexts, (ii) over polynomials within a ciphertext, (iii) over residue levels of a polynomial, and (iv) over coefficients of a residue polynomial. Instead of focusing on (iii) residue levels of a polynomial (similar to current methods of processing FHE data), the dedicated FHE accelerator 114 of the present disclosure focuses on (iv) exploiting coefficients of the residue polynomial for at least two reasons: (1) the number of residues decreases with the modulus level in the BGV scheme, leading to would-be idle RPAUs (residue polynomial arithmetic units) as the computation gets closer to bootstrapping; and (2) as the lowest level of parallelism, coefficient-level parallelism offers the best opportunity to exploit locality of reference.

Because of the focus on the coefficient-level parallelism, in numerous embodiments, NTT PE 156 is a high-radix NTT PE that employs a radix-256 butterfly network to allow the dedicated FHE accelerator 114 to employ ring dimension N=256² to enable bootstrapping and arbitrary-depth computations. Thus, the NTT PEs can compute 256²-point with only two round trips to memory for each coefficient. Smaller NTT's may also be computed with the NTT PEs through shortcuts in the butterfly network.

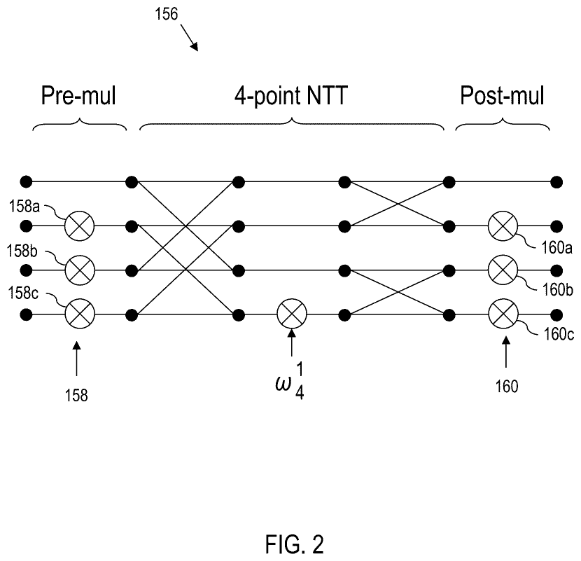

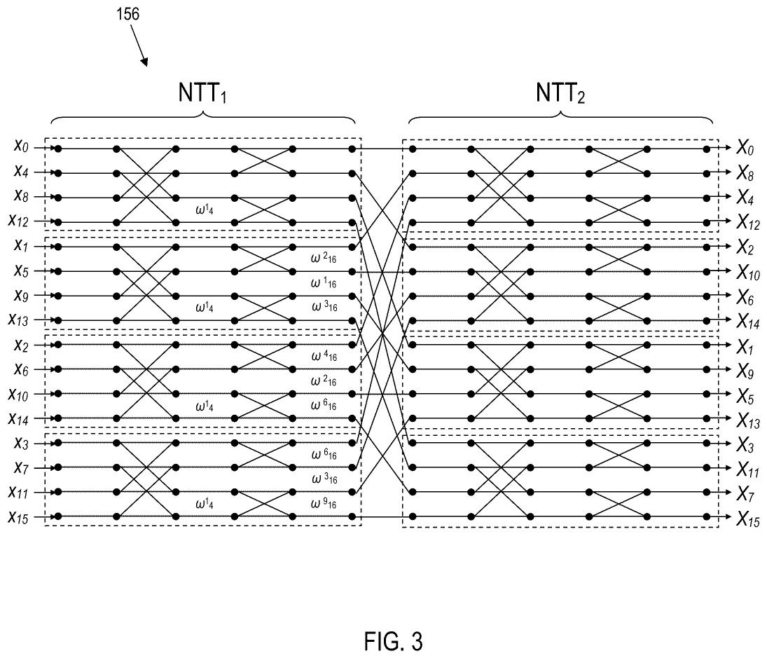

FIG. 2 illustrates a radix-4 negacyclic NTT unit with a pre-multiplier array 158 and a post-multiplier array 160. Note that only three of the inputs have multipliers 158a-c and three of the outputs have multipliers 160a-c. The result is a three-stage NTT architecture. FIG. 3 illustrates how to use the radix-4 NTT unit of FIG. 2 compute the full NTT flow graph in two passes that each take 4 chunks. In between passes through the NNT architecture is an implicit memory transposition that is enabled with a conflict-free CTB design-discussed herein. The NTT PE 156 uses four parallel three-stage NTT units. In several embodiments, each NTT unit is pipelined (e.g., forty pipeline stages) in order to run at high clock speeds (e.g., 2 GHZ). Together, these four parallel pipes consume 1024 32-bit residue polynomial coefficients at that 2 GHz rate-sufficient to consume all available data bandwidth from the CTB (150, FIG. 1).

A known performance inhibitor for NTTs is that successive NTT passes access coefficients at different memory strides, introducing access conflicts in memory. Current NTT accelerators present custom access patterns and reordering techniques that only work for small-radix NTT architectures or require expensive in-memory transpositions. However, such solutions do not work well for higher-radix (e.g., radix-256) architectures.

Conceptually, a N=N₁N₂=256²-point radix-256 NTT can be represented as a two-dimensional NTT, where the data is laid out with N₁=256 rows and N₂=256 columns. In this format, the inner N₁-point NTT coefficients are in column-major order, whereas the outer N₂-point NTT data is in row-major order. The crux of building conflict-free NTT schedules is to structure the data so that it can be read out in either order without bank conflicts. This requires a minimum of 256 independently addressable banks, each containing 216 bank addresses (for a total CTB size of 224 values).

In various embodiments of the FHE accelerator (114, FIG. 1), encrypted data are packed in ciphertexts that consist of very large arrays of polynomial coefficients. As an example, each ciphertext polynomial in the current implementation is stored as two arrays, each including 32 residue polynomials of 65536 coefficients each. In order to support all the required operations fast and efficiently, the data gets stored in a two-dimensional layout (e.g., 256 rows×256 columns, 128 by 128, etc.). Some operations require the data in row-major order and sometimes in column-major order. However, in order to sustain the full processing throughput the memory subsystem should be able to access one full row per cycle or one full column per cycle without any conflicts in addressing, meaning that each memory instance in the memory array will be accessed exactly once per operation at a single address for all the required data. In general, addressing all the elements of a row in parallel is trivial if they are all stored in one row of the memory array. However, when accessing columns, stripes of the memory are addressed with independent addresses, but elements of the same column must not conflict on the same stripe.

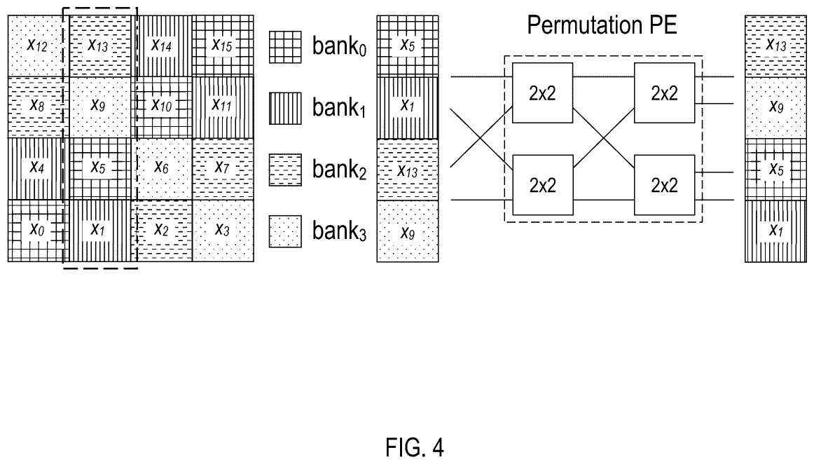

A conflict-free layout is employed based on XOR (exclusive OR) permutations, as illustrated in FIG. 4. In this layout, data with logical address {row, col} is stored at bank=row⊕col. This layout ensures that each unique index for every element in every row and column corresponds to a unique physically accessible bank of CTB memory (150, FIG. 1). Coefficients within a residue polynomial are arranged in a scrambled ordering to achieve conflict-free addressing. A “chunk” is defined as the number of coefficients to be accessed per cycle and is a multiple of the column or row width. For example, in a 2-dimensional matrix of size 256-by-256, four adjacent rows or columns may be accessed in a single cycle as a 4-by-256 or 256-by-4 sub-matrix chunk.

To derive the address location of a row/column in a particular memory the chunk index is XORed with the column/row index respectively, aligned at the MSB. For example, when reading rows or columns from the CTB, values come out of memory in bank order, one value for each bank from bank 0 to 255. However, operations like NTT require values in natural order: when accessing a row, values are sorted by column from 0 to 255, and when accessing a column, values are sorted by row from 0 to 255. Thus, when accessing row r, bank i is mapped to index i⊕r. Likewise, when accessing column c, map bank i is mapped to index i⊕c.

For example, if chunk size=row size=column size=256, then 256 independently addressable memory banks are required. For row mode, col={chunk^{i[7:0]}} for i=[0,255]. For column mode, row={chunk^{i[7:0]}} for i=[0,255].

In another example, if chunk size=2 times the row size, and row size=column size=256, then 128 independently addressable memory banks are required. For row mode, col={chunk^{i[7:1],i[0]}} for i=[0,255]. For column mode, row={chunk^{i[7:1],i[0]}} for i=[0,255].

Similarly, if chunk size=4 times the row size, and row size=column size=256, then 64 independently addressable memory banks are required. For row mode, col={chunk^{i[7:2],i[1:0]}} for i=[0,255]. For column mode, row={chunk^{i[7:2],i[1:0]}} for i=[0,255].

In a further example, if chunk size=8 times the row size, and row size=column size=256, then 32 independently addressable memory banks are required. For row mode, col={chunk^{i[7:3],i[2:0]}} for i=[0,255]. For column mode, row={chunk^{i[7:3], i[2:0]}} for i=[0,255].

This approach may be extended further to an even higher degree of parallelism by reducing the bits of the chunk index and XORing the upper bits of the row and column index with the chunk index while leaving the rest of the index unmodified.

In many embodiments, a physical mapping of the ciphertext buffer (CTB) includes 1024 SRAMs organized into sixty-four bank sets of sixteen SRAMs. All SRAMs in a bank set share an address line, so when accessing chunks in row-wise mode (memInstr_bits_rowCol==‘0’), the physical SRAM addresses for all bank sets are equal to memInstr_bits_memAddr. However, this is not the case for column-wise access. In column-wise access mode, the sixty-four addresses to each bank set are calculated by the CTB based on the value of memInstr_bits_memAddr and an index [0-63] assigned to the bank set. For these address calculations, it is useful to break the thirteen-bit memInstr_bits_memAddr into a seven-bit page [12:6] and a six-bit chunk [5-0]. A further bit determines whether the access is row-wise or column-wise.

As described above, a custom “on-the-fly” Permutation (PE 154, FIG. 1) computes these XOR-based permutations as data moves to or from the other PEs in the accelerator. By implementing a slightly more general permutation PE (discussed below) that supports permutations of the form i→(i·a+b)⊕c, the Permutation PE may be used to implement conflict-free XOR permutations, but also any BGV ring automorphism without additional hardware.

In several embodiments, the CTB includes coefficients within a residue polynomial that are arranged in a scrambled ordering to achieve conflict-free addressing. The 256 coefficients on the input of a single permutation PE (discussed in detail below) are ordered for row mode as: col={chunk\hat{ }i[7:2], i[1:0]} for i=[0,255], and for column mode as: row={chunk\hat{ }i[7:2], i[1:0]} for i=[0,255]. The permutation PE reorders data coming out of the CTB, as discussed below.

Using these types of structures, the lack of conflict when addressing the CTB allows all the data to be stored in single-port memories and with a single-cycle operation per chunk without loss of performance.

In alternate embodiments, instead of the XOR method described above, other methods to ensure conflict-free memory access exist that also ensure that that every column index maps to a different physical memory of the memory array. For example, generating the column index by incrementing an array location using a number that is relative prime to the width of the array. However, such an addressing scheme would require more complex logic than the XOR method described above.

Similar to polynomial residue coefficients, twiddle factors of many embodiments of the dedicated FHE accelerator described herein are 32-bit integers. However, several embodiments use different sizes for twiddle factors (e.g., 64 bits, 80 bits, 128 bits, etc.) to the point where the size of the twiddle factors may be variable and set with a parameter. Regardless, for a ring of dimension N, there are N−1 twiddle factors for each residue for both forward and inverse NTT, and a maximum of 56 residues at max-capacity key switching, together requiring ˜29.4 MB of twiddle factor material in a naïve implementation. Normally, the four NTT units have 5116 multipliers total that must be fed each cycle with twiddles, requiring massively parallel access into this storage memory. However, the FHE accelerator prevents this storage requirement in two ways. First, a new twiddle decomposition method reduces a required parallel number of distinct twiddle accesses. Second, a custom twiddle factor factory drastically reduces a number of twiddles stored.

Moreover, twiddle factors are different between forward NTT operations and inverse NTT operations. As the amount of memory needed to store the twiddle factors ranges in tens of megabytes, it would time consuming to load onto the chip through external memory or the host interface every time an NTT operation needs to be performed. Therefore, the twiddle factors are determined on chip via mathematical PEs (e.g., MACs, etc.) on the fly. and consumed at full speed to keep the NTT unit processing at the desired throughput without stalling. A very small number of the parameters are needed to be stored ahead of time and stored and the rest can be determined using multiplications, as they are powers of the same constant (root of unity).

The twiddle factors are split into three categories, specifically corresponding to the time needed for processing relative to the NTT operation: (1) Pre-twiddles, which are the constants that are multiplied by the data before the NTT operation; (2) Butterfly twiddles, which are the constants that are used by the NTT butterfly network itself during the NTT operation execution; and (3) Post-twiddles, which are the constants that are multiplied by the data after the NTT butterfly operation.

For a forward negacyclic NTT, each input xᵢ is premultiplied (using the pre-multipliers 158, FIG. 2) by the twiddle φⁱ=ωⁱ₂N. The additional negacyclic twiddles are decomposed to extract a regular pattern and are distributed evenly between the two NTT passes in the flow graph. This provides benefits over other solutions. For example, it can be seen that the pre-multiplications become identical for each chunk in both passes. This allows the four NIT units to share the same pre-multiply twiddle which drastically reduces the total number of pre-multiply twiddles from N=256² to 2·√N, easily fitting in a smaller amount of memory. Further, the internal butterfly twiddles (powers of ω₂₅₆) are a strict subset of the pre-multiply twiddle in the first pass (powers of ω₅₁₂), so both can be routed from the same small memory.

The remaining twiddle factor complexity sits in the post-multiply twiddles. For each chunk k, there are 255 twiddles ω^{ik}₂₅₆². A memory storing vectors of 255 twiddles with depth 255 for each residue is still much too large. To reduce the width, a power generator circuit trades memory storage for multipliers. The main idea is as follows. By using the identity ω^{ik}₂₅₆²=ωⁱ₂₅₆²/k it can be observed that the required twiddles for chunk k are always the 255 consecutive powers of a seed value ω=ω₂₅₆²/k. Using only a single seed ω, its successive powers can be computed in a number of multiply layers. The first layer computes ω² from ω, with a single multiplier. The second layer takes ω² and ω to compute ω⁴ and ω³, and so forth. Every multiplier in the circuit produces a unique value that is used as an output, so to generate 255 powers from a single w requires only 254 multipliers. Using this technique to calculate twiddle factors while data is being processed instead of storing vectors of 255 twiddles with depth 255 for each residue, it suffices to store just the single seeds with depth 255. Thus, very little long-term storage is required. Additionally, by not having to retrieve roots of unity from the main memory of the FHE accelerator halves the memory bandwidth requirements of the computation.

There are tradeoffs between the number of roots that are saved versus the number of roots that are calculated on the fly. Storing more parameters lowers the latency and complexity of the computation but requires more storage area and vice-versa. In a balanced approach, where enough powers of the root of unity are stored so that the entire computation of the rest can be completed in a similar amount of time as the computation that will utilize them. This way the values are generated when they are needed and then discarded and do not need to be pre-computed until they are needed, so they do not have to be stored at all before or after they are used.

The techniques above can be used for the inverse NTT as well.

The permutation PE is a processing element that (for a Permutation PE with a size of SIZE) receives SIZE values as an input and produces SIZE values at the output, where SIZE is a power of two and the output is a re-ordered version of the input. As discussed above, a slightly more general permutation PE supports permutations of the form i→(i·a+b)⊕c, such that the Permutation PE may be used to implement conflict-free XOR permutations, but also any BGV ring automorphism without additional hardware. Each permutation unit reorders an array of input coefficients to produce a permuted output array of the same length.

Concatenating two permutation PEs provides for implementation of all required permutations of input to output rotations, which allows the device to perform the automorphism and NTT operations without using additional memory. For example, this means that the data gets read out of memory one row at a time, gets reordered on the fly, and gets written back in the same location in memory they came from, without needing to use temporary scratch memory for any intermediate results.

In concatenated permutation PEs, a first permutation PE is a read permutation PE, and a second permutation PE is a write permutation PE. Note however, that the generic structure of both permutation PEs are the same: logic to perform i→(i·a+b)⊕c (as is known, the ⊕ symbol is an exclusive OR (XOR)). The Read Permutation PE unscrambles data in conflict-free CTB bank ordering in order to pass it to the other PEs expecting natural ordering (e.g., an NTT PE, an arithmetic PE, etc.). It is a specialized instance of the more general Permutation PE that only implements permutations i→i⊕c, requiring values a=1 and b=0 (c ranges from 0 to SIZE−1). The input array from the CTB banks at each sender (i) is sent to an output as i XOR c.

The Write Permutation PE passes data in the opposite direction (i.e., from the NTT to the CTB). It implements the general permutation i→(i·a+b)⊕c (where a is an odd number) in order to re-scramble the data into its conflict-free layout, or to compute ring automorphisms. This class of permutations is sufficient to perform any ring automorphism in combination with the shuffling required by the conflict-free memory layout. For testing, the formula can be written as permutation i→(i·a+b) % SIZE⊕c, where % is a modulo operator.

In the latter case, the output of the Read Permutation PE is fed directly into the input of the Write Permutation PE to achieve the complete operation of the automorphism. As can be seen, the Read permutation PE includes a=1 and b=0, but the Write permutation PE does not impose that restriction-only that a be an odd number. In some implementations, the Read permutation PE may be hardcoded to include a=1 and b=0 to reduce the amount of logic required for those permutation PEs.

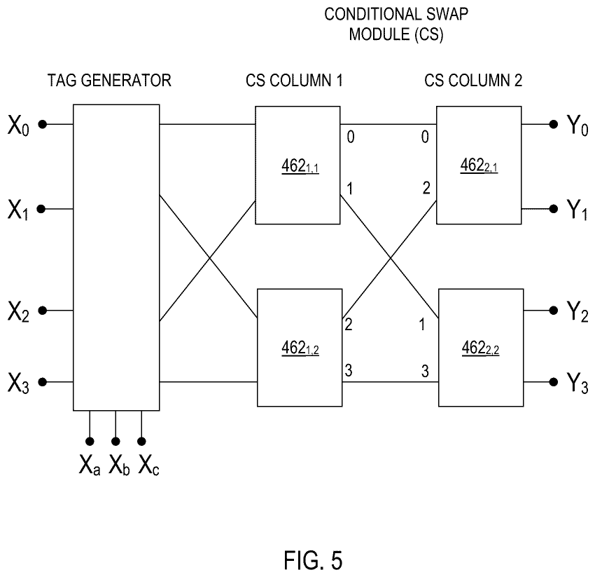

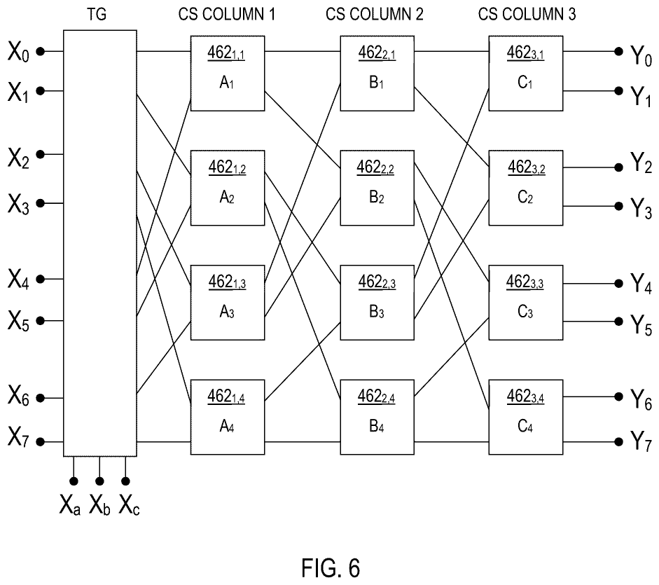

As discussed above, a permutation PE can be sized to any power of two. For example, FIGS. 5-6 illustrate size-four and size-eight permutation PEs. Each permutation PE includes inputs X_{0-(SIZE-1)}, inputs for a, b, and c Xa-c, outputs Y_{0-(SIZE-1)}, and a network of several conditional step nodes (CSs) 562_{k,r}. The CSs are arranged in columns and rows, where k is a numbered column and r is a numbered row. For example, 562_{2,1} is a CS in column 2, row 1. A number of rows and columns is based on the size of the permutation PE (SIZE) using the equation k=log₂(SIZE) and r=SIZE/2. Therefore, as can be seen in FIG. 5, a size-four permutation PE includes two columns and two rows of CSs, while a size-eight permutation PE includes three columns and four rows.

Using the values of the (a, b, c) inputs, a routing tag (i→(i·a+b) % SIZE⊕c) can be added to the input data at each CS 562 node to facilitate a routing process without having to control each individual CS node 562 in the network externally. The tag will have size log 2(SIZE). At each CS node the tag is inspected and if a control value is one, then the inputs values to the CS node are swapped. Otherwise, the values on the inputs of the CS node pass through in the same order they arrived. The control bit for a node at column j of the network corresponds to the j^{th} bit of the tag value.

Note that in some embodiments, when values are sent to the CS nodes, there are appended bits of the values that include the control bits that are only used for a specific column. Therefore, in some embodiments, additional optimization of the permutation PE architecture may include reducing the number of bits of the value sent to the CS nodes by one for every column, because once a bit is used at a column (for that column), the bit may be removed from the values being sent between CS nodes.

In other embodiments, the control bits may be stored in tables or calculated and transmitted differently to the CS nodes.

In numerous embodiments, the permutation PEs are arranged in a network topology such that each node receives a pair of inputs and either outputs them in the same or reversed order. A small network 460 is shown in FIG. 4 to create a 4×4 network from four 2×2 permutation PEs. However, other topologies may be used (e.g., a 256 by 256 as discussed above).

In an example permutation PE network, if it is assumed that the width of the PE network is a power of 2 and a, b and c are the three coefficients, any permutation of the form i->(i*a+b) XOR c, for any a (being an odd number), b, and c may be performed. This class of permutations is sufficient to perform any ring automorphism in combination with the shuffling required by the conflict-free memory layout.

In quick summary, assuming the size of the permutation PE is a power of 2 and a, b and c are the three coefficients, any permutation of the form i→(i*a+b) XOR c, for any a (being an odd number), b, and c can be performed. This class of permutations is sufficient to perform any ring automorphism in combination with the shuffling required by the conflict-free memory layout discussed herein.

As discussed above, the dedicated FHE accelerator uses key-switching to homomorphically encrypt and decrypt the data. These key-switching operations require keys that are large and pre-calculating them in advance and storing them in memory takes a substantial amount of memory storage as well as a large amount of memory bandwidth when fetching them from external memory. However, it has been found that a first half of each of the keys is just required to be randomized (with a uniform distribution over a finite field). Therefore, in some embodiments, a finite field random number generator (i.e., a uniform random number generator) with a programmable seed and modulus parameter is used to generate the first half of each key-switching key as it is needed (i.e., “on the fly”) instead of pre-calculating and storing both halves of the key-switching keys in memory. The programmable seed provides repeatability in generating the same key multiple times if needed. This on-the-fly calculation cuts down on required memory space and reduces memory bandwidth to about half during key-switching.

Further, in various embodiments, instead of the second half of a key-switching key being pre-calculated, the second half of a key-switching key is generated based on the first half of a key-switching key and may be further based on user data, program data, or both. Thus, the second half of the key-switching key may be pre-calculated and stored in memory or may be derived on-the-fly from the first half of the key-switching key. In some examples, the full key-switching key is generated by appending the second half of the key-switching key to the first half of the key-switching key.

In implementations where the first half of each key-switching key is generated using a random number generator, for each prime modulus a full residue polynomial worth of random data is generated. Therefore, the logic necessary to make the logic for the random number generator fast. Thus, the random number generator should have a large degree of parallelism to ensure timely generation of a random polynomial, (OUTPUT_SIZE). The random number generator generates OUTPUT_SIZE random numbers per cycle. A residue polynomial has N number of residues, so the random number generator requires N/OUTPUT_SIZE number of cycles to generate the full polynomial.

In several implementations, the random number generator operates in two modes: configuration mode and generation mode. In configuration mode, configuration commands are used to configure the random number generator, which occurs before generation mode. In configuration mode, generation parameters (e.g., sent as part for the configuration commands, determined using the configuration commands, etc.) are set up and stored in registers for the random number generator to use in generation mode. For example, generation parameters may include s_val (seed value), g_val (generator value), p_val (prime modulus value), rng_val, etc.

In generation mode, the random number generator generates OUTPUT_SIZE values per cycle. For proper seeding, each period p_val corresponds to OUTPUT_SIZE s_val values. There are two p_val and s_val setting strategies to avoid the parallel generators from producing overlapping/correlated values.

In the first setting strategy, the s_val are equally spaced in the period p_val, so that:

$$s\_val [ i , j ] = ( s\_val [ i , j - 1 ] + g\_val [ i ] * ( p\_val [ i ] / OUTPUT\_SIZE ) ) mod p\_val [ i ]$$

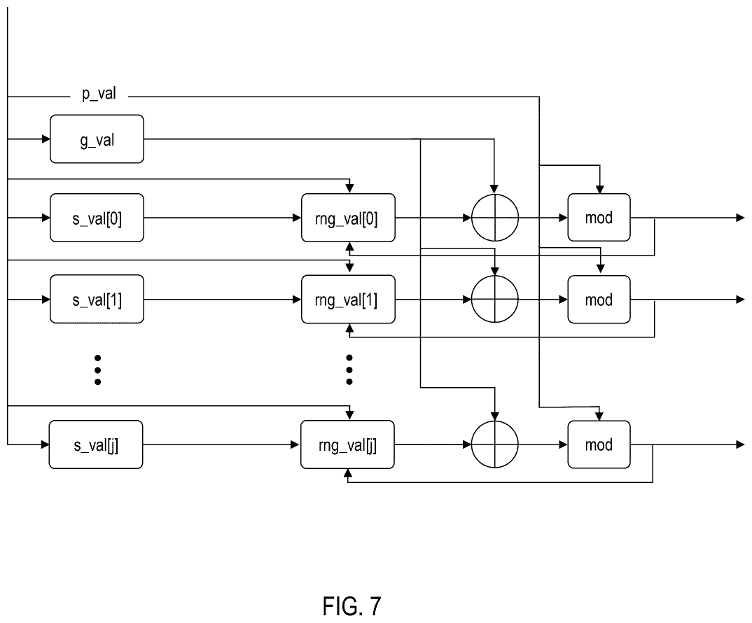

for j=1 . . . . OUTPUT_SIZE−1, As shown in FIG. 7. In other words, each of the parallel generators should be running over a non-overlapping segment of the random number generator's period, which is commonly equal to the prime modulus of the polynomial that is being generated.

In the second setting strategy, the random number loads a seed number into a register (based on the configuration commands): rng_val[I,j]=s_val[I,j], for all j. The random number generator also receives p_val[i] which is used for the modulo operation. Further, the RNG loads an appropriate g_val[i] from the configuration in order to set up the generate command.

After receiving a generate command, the random number generator generates data for as many cycles as needed to generate data needed to produce one residue of the key-switching key (or half-key), starting from the last value generated and updating forward. For each cycle, the random number generator does not reload the seed, prime, generator values, or combinations thereof, but instead continues from where it left off. If the parameters for the generator need to change then a configuration command is necessary. The process repeats for each residue of the key-switching key until the full key-switching key is assembled. Each residue polynomial has its own seed and prime modulus, so the configuration and generation process has to repeat as many times as there are residues. For each prime modulus i and output value j the generator updates as follows:

$$rng\_val [ i , j ] = ( rng\_val [ i , j ] + g\_val [ i ] ) mod p\_val [ i ]$$

A block diagram of an implementation of a random number generator is shown in FIG. 7. Again the number of seed values (s_val) denoted the OUTPUT_SIZE.

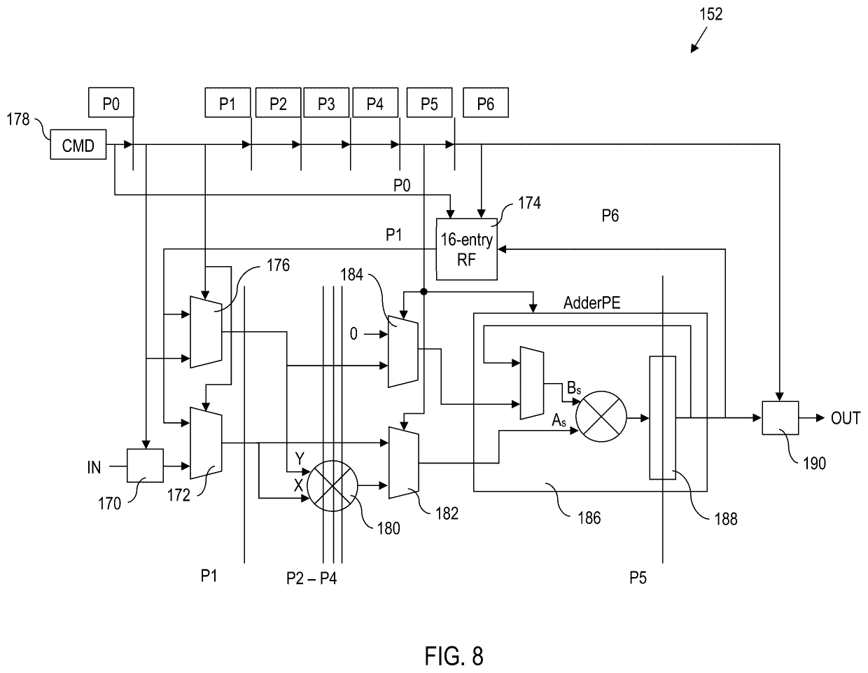

Turning to FIG. 8, the Key-Switching operation in dedicated FHE accelerator is one of the most computationally expensive and frequent operations used. As such, a program sequence schedules these operations in such a way that they could take advantage of a custom-design Multiply-Accumulate unit enhanced with a local register file 174 so that sum-of-products (SOP) intermediate results can be stored locally and thus eliminated the need for writing them back in memory after each computation, which eliminates a need to fetch them again for the next sum.

The MAC PE 152 includes an input receiver 170 that goes to a multiplexer 172 that chooses between the input 170 or a register file 174. A second multiplexer 176 chooses between another input (CMD) 178 and the register file 174. The outputs of the two multiplexers 172, 276 feed a multiplier 180 (which can also be bypassed). The output of the multiplier 180 (which is shown as a three-stage pipelined multiplier in FIG. 5) feeds a third multiplexer 182 that chooses between the first multiplexer 172 and the multiplier 180. A fourth multiplexer 184 chooses between 0 and the second multiplexer 176. Then, the outputs of the third and fourth multiplexers 182, 184 feed an accumulator 186 that either accumulates (similar to conventional MAC functions) or is used as an adder (which may also be used for subtraction), depending on an operation selected. An output of the accumulator feeds a register 188, which in turn feeds the register file 174. Note that the command (i.e., operation) will dictate the select lines of the multiplexers 172, 176, 182, 184. The register 188 of the accumulator 186 also feeds an output 190 of the MAC PE. Each pipeline stage is represented by P0-P6. The vertical lines P1-P6 indicate where in the MAC PE the pipeline stage is located.

In some embodiments, a base extension commonly used in key-switching, involves the register file 174 inside the MAC PE to enable local data reuse in tight arithmetic loop operations. The size of the register file is tailored to the loop size that is common in fast-base extension operations found in FHE key-switching algorithms.

For example, an inner loop of the key switching algorithm (also referred to as the “fast base extension” subroutine) involves pre-computing a table of about twelve or so residue polynomials and then computing many (up to around forty) different weighted sums of those twelve values, with constant weights. Naive designs (i.e., current methods) would require twelve multiplications to compute the table, plus four-hundred-eighty multiplications and four-hundred-forty additions to compute the weighted sums, for a total of 1372 memory reads+932 memory writes=2304 memory accesses. With an accumulator and no local registers, it would require twelve multiplications for the table, plus four-hundred-eighty multiply-accumulate operations (of which forty need to write back to memory) for a total of 492 memory reads+52 memory writes=544 memory accesses.

However, the MAC PE is designed to be able to execute this algorithm with minimal memory traffic. Precomputing the table requires 12 memory reads, but the table itself can be stored entirely within the local register file. Computing each weighted sum requires twelve multiply-accumulate operations and no memory reads-all operands are either local registers or immediates. Further, only one memory write is required to save the result of each weighted sum. In total, the routine takes twelve memory reads and forty writes which equals fifty-two memory accesses in total. This is a forty-four times reduction compared to the naive design or a ten times reduction compared to the accumulator-only design.

The structure of the MAC PE described above supports modulo arithmetic operations (ring-based arithmetic operations), because both the multiplier 180 and adder 186 include modular reduction functionality. Thus, the output of the MAC PE is already reduced to be an element of the ring. For example, the multiplier used in the MAC PE calculates:

$$Product = ( a * b ) mod n$$

Such a process requires three multiplications, one addition, one comparison and one subtraction. Similarly the adder is designed to calculate:

$$Sum = ( a + b ) mod n$$

Such a summing requires one addition, one comparison and one subtraction. Thus, one MAC operation in the MAC PE could perform nine operations that would be necessary in a traditional compute platform that operates on integer operations or typical processor. This nine-to-one operation reduces a number of memory accesses required.

The MAC unit design achieves not just a reduction in absolute memory traffic, it also reduces a total execution time of operations, as well as a percentage of cycles that require memory accesses. The base extension routine in the naive design would do 2304 memory accesses over 2304 elapsed cycles, using 100% of the memory bandwidth over that time. The accumulator-only design would do 544 memory accesses in 544 cycles, again using 100% of available memory bandwidth. With a register file, the routine does 52 memory accesses over 492 cycles, which is only 10.6% of the available memory bandwidth. The other 89.4% remains available for performing other operations in parallel, such as computing NTTs and transferring data to and from off-chip memory. As FHE processing systems are constrained by an amount of data that can be fetched and written back into memory, the memory traffic reduction that the MAC unit provides has a direct impact on the overall performance of the system.

The different PEs of the system herein allow the system to be scalable. For example, the PEs may be repeated thousands of times to scale the device. As another example, many devices (100, FIG. 1) may be added to the system to upscale the system.

In some embodiments, the system and/or method can include and/or be performed using a device for executing programs and processing data that have been homomorphically encrypted. In some such embodiments, the device can include an interface to a host system board, a mass memory, and a high-speed bus interconnect coupled to the mass memory and the interface. Further, in some such embodiments, a dedicated fully homomorphic encryption accelerator can be coupled to the mass memory, the high-speed bus interconnect, and the interface. In some such embodiments, the interface can both receive input data to be stored in the mass memory and send output data from the mass memory to the processing board. In some such embodiments, the dedicated fully homomorphic encryption accelerator can convert the input data to output data by performing operations on the input data.

Additionally or alternatively, in some embodiments, the system and/or method can include and/or implement one or more techniques for reducing calculation time for processing fully homomorphic encrypted (FHE) data, such as wherein such technique(s) include pre-calculating a second half of a key-switching key, storing the second half of the key-switching key in memory, and receiving FHE data. In some such embodiments, after the FHE data is received, the method determines a first half of the key-switching key by randomly generating a first half of the key-switching key. In some such embodiments, the key-switching key is then constructed by retrieving the second half of the key-switching key from the memory and appending the second half of the key-switching key to the first half of the key-switching key. In some such embodiments, after the key has been constructed, a key-switching operation is performed on the FHE data using the key-switching key. In some such embodiments, instead of the second half of a key-switching key being pre-calculated, the second half of a key-switching key is generated based on the first half of a key-switching key.

Additionally or alternatively, in some embodiments, the system and/or method can include and/or implement one or more techniques for conflict-free memory accesses, preferably wherein such technique(s) include storing data in a memory. In some such embodiments, the memory can be accessed by row or column, and the data is arranged in a scrambled ordering. Further, in some such embodiments, the process includes defining a bank as a specified row exclusive or-ed with a specific column. In some such embodiments, when addressing a row, mapping a bank i to an index i xor the row; and/or when addressing a column, mapping a bank i to an index i xor the column.

Additionally or alternatively, in some embodiments, the system and/or method can include and/or be performed using a device for processing fully homogeneous encrypted data. In some such embodiments, the device can include a command input with pipeline stages and a register file coupled to the command input via a non-pipelined stage and an ultimate pipelined stage. Further, in some such embodiments, the device includes a first multiplexer with a first input coupled to the register file, a second input coupled to a data input, and a select coupled to the first pipeline stage of the command input, and a second multiplexer with a first input coupled to the register file, a second input coupled to a first pipeline stage of the command input, and a select coupled to the first pipeline stage of the command input. In some such embodiments, a multiplier couples to outputs of the first multiplexer and the second multiplexer, wherein the multiplier has a predetermined number of pipeline stages. In some such embodiments, a third multiplexer includes a first input coupled to an output of the multiplier, a second input coupled to the output of the first multiplexer, and a select coupled to a penultimate pipeline stage of the command input, and a fourth multiplexer includes a first input coupled to ground, a second input coupled to the output of the second multiplexer, and a select coupled to the penultimate pipeline stage of the command input. Moreover, in some such embodiments, the device includes an adder element with a first input coupled to an output of the third multiplexer, a second input coupled to an output of the fourth multiplexer, a select line coupled to the penultimate pipeline stage of the command input, and an output coupled to the register file.

However, the system and/or method can additionally or alternatively include any other suitable elements.

A numbered list of specific examples of the technology described herein are provided below. A person of skill in the art will recognize that the scope of the technology is not limited to and/or by these specific examples.

1. A system for processing homomorphically encrypted data, the system comprising:
a memory that stores encrypted data;
a first multiply-accumulate (MAC) unit communicatively coupled to the memory, wherein the first MAC unit generates modified encrypted data by performing a modular arithmetic operation on the encrypted data based on a prime modulus parameter value;
a random number generator that generates a first portion of a key switching key using a programmable seed value and the prime modulus parameter value; and
a second MAC unit communicatively coupled to the random number generator and to the first MAC unit, wherein the second MAC unit:
   receives the first portion of the key switching key from the random number generator;
   receives the modified encrypted data from the first multiply-accumulate unit;
   determines a second portion of the key switching key; and
   performs a key switching operation on the modified encrypted data based on the first and second portions of the key switching key.
      2. The system of Specific Example 1, wherein the second multiply-accumulate unit comprises:
a register file;
a plurality of multiplexers, wherein a first multiplexer of the plurality of multiplexers is communicatively coupled to the register file; and
a plurality of multipliers, wherein each multiplier of the plurality of multipliers is communicatively coupled to a respective multiplexer of the plurality of multiplexers
   3. The system of Specific Example 2, wherein performing the key switching operation on the modified encrypted data comprises:
generating an intermediate value, comprising performing a first multiplication operation;
storing the intermediate value in the register file;
after storing the intermediate value, retrieving the intermediate value from the register file; and
performing a second multiplication operation on the intermediate value retrieved from the register file.
   4. The system of Specific Example 3, wherein retrieving the intermediate value from the register file comprises, at the first multiplexer:
selecting the register file as a selected source;
receiving the intermediate value from the register file; and
based on selecting the register file as the second selected source, providing the intermediate value to a first input of a first multiplier of the plurality.
   5. The system of Specific Example 3 or 4, wherein generating the intermediate value further comprises:
at a second multiplexer of the plurality:
   selecting a second selected source from the group consisting of: the register file and an input port of the second MAC;
   receiving selected data from the selected source; and
   providing the selected data to a second input of the first multiplier;
at the first multiplier, computing a first product by performing the first multiplication operation, wherein the first multiplication operation is performed using the selected data as a factor; and
determining the intermediate value based on the first product.
   6. The system of Specific Example 5, wherein:
generating the intermediate value further comprises, at the first multiplexer, providing a second factor to the first input of the first multiplier, wherein the first multiplication operation is performed further using the second factor, wherein the first product is equal to the product of the selected data and the second factor; and
determining the intermediate value based on the first product comprises:
   at the first multiplier, providing the first product to a third multiplexer;
   at the third multiplexer, providing the first product to an adder of the second MAC; and
   at the adder, computing the intermediate value using the first product.
      7. The system of any of the preceding Specific Examples, wherein determining the second portion of the key switching key comprises, at the second MAC unit, generating the second portion of the key switching key using the first portion.
      8. The system of any of the preceding Specific Examples, wherein determining the second portion of the key switching key comprises, at the second MAC unit, receiving the second portion from the memory.
      9. The system of any of the preceding Specific Examples, wherein:
the random number generator comprises a plurality of generator units;
generating the first portion of the key switching key is performed using a plurality of seed values comprising the programmable seed value, wherein each seed value of the plurality is associated with a different generator unit of the plurality; and
generating the first portion of the key switching key comprises, for each generator unit of the plurality: generating a respective sub-portion of the first portion of the key switching key using the associated seed value of the plurality.
   10. The system of Specific Example 9, wherein:
the prime modulus parameter value defines a ring of integers reduced modulo the prime modulus parameter value; and
the seed values of the plurality are evenly distributed across the ring.
   11. A method for processing homomorphically encrypted data, the method comprising:
receiving encrypted data;
generating modified encrypted data based on the encrypted data, comprising, at a multiply-accumulate (MAC) unit, based on a prime modulus parameter value, performing a modular arithmetic operation on the encrypted data; and
after performing the modular arithmetic operation, performing a key switching operation on the modified encrypted data, wherein performing the key switching operation comprises:
   at a random number generator, generating a first portion of a key switching key using: a generator value, the prime modulus parameter value, and a plurality of programmable seed values equally spaced throughout a generation period; and
   at the MAC unit:
      receiving the first portion of the key switching key;
      determining a second portion of the key switching key; and
      transforming the modified encrypted data using the first and second portions of the key switching key.
         12. The method of Specific Example 11, wherein performing the key switching operation on the modified encrypted data further comprises, at the MAC unit:
generating an intermediate value, comprising performing a first multiplication operation;
storing the intermediate value in a register file of the MAC unit;
after storing the intermediate value, retrieving the intermediate value from the register file; and
after retrieving the intermediate value from the register file, performing a second multiplication operation on the intermediate value.
   13. The method of Specific Example 12, wherein:
performing the key switching operation on the modified encrypted data further comprises, at the MAC unit, receiving a constant weight value via an immediate value input; and
performing the second multiplication operation comprises computing a weighted sum by multiplying the intermediate value with the constant weight value.
   14. The method of any one of Specific Examples 11-13, wherein determining the second portion of the key switching key comprises receiving the second portion of the key switching key from a memory.
   15. The method of any one of Specific Examples 11-14, wherein determining the second portion of the key switching key comprises generating the second portion of the key switching key based on the first portion of the key switching key.
   16. The method of any one of Specific Examples 11-15, wherein the generation period is a ring of integers reduced modulo the prime modulus parameter value.
   17. The method of any one of Specific Examples 11-16, wherein transforming the modified encrypted data using the first and second portions of the key switching key further comprises performing a second plurality of modular arithmetic operations on the modified encrypted data.
   18. The method of any one of Specific Examples 11-17, wherein the encrypted data is received from a memory unit.
   19. The method of Specific Example 18, further comprising, at the random number generator, receiving the plurality of programmable seed values, the generator value, and the prime modulus parameter value from the memory unit.
   20. The method of any one of Specific Examples 11-19, wherein performing the key switching operation further comprises generating the key switching key by appending the second portion of the key switching key to the first portion of the key switching key.
   21. A system for processing homomorphically encrypted data, the system comprising:
a cipher text buffer (CTB) comprising a plurality of independently addressable memory banks;
a permutation processing element communicatively coupled to the cipher text buffer, the permutation processing element comprising:
   a read permutation processing element that: receives first data from the CTB in a CTB ordering, performs XOR-based permutations to reorder the first data from the CTB ordering to a natural ordering, and outputs the first data in the natural ordering; and
   a write permutation processing element that: receives second data in the natural ordering, performs XOR-based permutations to convert the second data from the computational ordering to the CTB ordering, and outputs the second data to the CTB in the CTB ordering; and
a number theoretic transform (NTT) unit communicatively coupled to the CTB via the permutation processing element, wherein the number theoretic transform unit: receives the first data in natural ordering from the read permutation processing element, performs NTT operations on the first data, and outputs the second data in natural ordering to the write permutation processing element.
   22. The system of Specific Example 21, wherein:
the first data comprises a plurality of values, the plurality of values associated with a set of row indices and a set of column indices;
each value of the plurality is stored in a respective memory bank of the plurality of independently addressable memory banks, the plurality of independently addressable memory banks defining a set of bank indices;
each value of the plurality is associated with:
   a respective row index r of the set;
   a respective column index c of the set; and
   a respective bank index i of the set, the respective bank index indicative of the respective memory bank in which the value is stored, wherein i=r⊕c, where ⊕ is the XOR operator;
receiving the first data in the CTB ordering comprises receiving each value of the plurality ordered based on the set of bank indices; and
outputting the first data in the natural ordering comprises outputting each value of the plurality ordered based on at least one of the set of row indices or the set of column indices.
   23. The system of Specific Example 22, wherein the write permutation processing element performs XOR-based permutations of the form (j×a+b)⊕d, wherein j is an input data index, a is an odd integer, and b and d are integers.
   24. The system of any one of Specific Examples 21-23, wherein:
the plurality of independently addressable memory banks defines a rectangular array of memory banks defining a plurality of rows and a plurality of columns;
the system is operable to access a row of the CTB, the row associated with a row index r, wherein accessing the row comprises, at the read permutation processing element:
   receiving row data from the CTB in the CTB ordering, the row data comprising a first plurality of values, each value of the first plurality associated with a respective bank index i;
   performing XOR-based permutations to reorder the row data in to the natural ordering, comprising, for each value of the first plurality, mapping the value to a respective column index cᵢ=i⊕r, where ⊕ is the XOR operator; and
   outputting the row data in the natural ordering such that the values of the first plurality are sorted sequentially in order of increasing column index; and
the system is operable to access a column of the CTB, the column associated with a column index c, wherein accessing the column comprises, at the read permutation processing element:
   receiving column data from the CTB in the CTB ordering, the column data comprising a second plurality of values, each value of the second plurality associated with a respective bank index j;
   performing XOR-based permutations to reorder the column data in to the natural ordering, comprising, for each value of the second plurality, mapping the value to a respective row index rⱼ=j⊕c; and
   outputting the column data in the natural ordering such that the values of the second plurality are sorted sequentially in order of increasing row index.
      25. The system of any one of Specific Examples 21-24, further comprising a multiply-accumulate (MAC) unit communicatively coupled to the CTB and the permutation processing unit, wherein the MAC unit generates a sequence of powers based on a first seed value.
      26. The system of Specific Example 25, wherein:
the NTT unit receives the sequence of powers from the MAC unit via the permutation processing unit; and
performing the NTT operations on the first data is performed using the sequence of powers.
   27. The system of Specific Example 25 or 26, wherein:
the CTB stores a set of seed values comprising the first seed value; and
the MAC unit receives the first seed value from the CTB.
   28. The system of Specific Example 27, wherein the set of seed values comprises a set of roots of unity.
   29. The system of any one of Specific Examples 21-28, wherein:
the read permutation processing element is communicatively coupled to the write permutation processing element;
the read permutation processing element receives third data from the CTB in the CTB ordering; performs XOR-based permutations of the form i→i⊕d, where ⊕ is the XOR operator, to reorder the third data from the CTB ordering to the natural ordering; and outputs the third data in the natural ordering to the write permutation processing element;
the write permutation processing element receives the third data from the read permutation processing element in the natural ordering; performs XOR-based permutations of the form i→(i×a+b)⊕c, where a is an odd integer and i, b, and c are integers, to generate modified third data by applying a ring automorphism to the third data, and outputs the modified third data.
   30. The system of Specific Example 29, wherein the write permutation processing element comprises an array of permutation nodes arranged in a network topology.
   31. A system for processing homomorphically encrypted data, the system comprising:
a cipher text buffer (CTB) comprising a plurality of independently addressable memory banks;
a permutation processing element communicatively coupled to the CTB, wherein the permutation processing element:
   receives first data from the CTB; and
   performs XOR-based permutations on the first data to generate reordered first data;
a multiply-accumulate (MAC) unit comprising a set of multipliers, the MAC unit communicatively coupled to a memory, wherein the MAC unit:
   receives a set of seed values from the memory;
   at the set of multipliers, generates a sequence of powers of a first seed value of the set; and
   outputs the sequence; and
a number theoretic transform (NTT) unit communicatively coupled to the permutation processing element and to the MAC unit, wherein the NTT unit:
   receives the reordered first data from the permutation processing element;
   receives the sequence from the MAC unit;
   generates transformed first data by performing an NTT operation, comprising performing operations on the reordered first data using the sequence; and
   outputs the transformed first data to the CTB via the permutation processing element.
      32. The system of Specific Example 31, wherein the memory is the CTB.
      33. The system of Specific Example 31 or 32, wherein the set of seed values comprises a set of roots of unity.
      34. The system of any one of Specific Examples 31-33, wherein the permutation processing element comprises:
a read permutation processing element that:
   receives the first data from the CTB;
   performs the XOR-based permutations on the first data; and
   outputs the reordered first data; and
a write permutation processing element that:
   performs second XOR-based permutations on the transformed first data to generate reordered transformed first data; and
   outputs the reordered transformed first data to the CTB.
      35. The system of any one of Specific Examples 31-34, wherein the sequence comprises a set of post-twiddle factors associated with the NTT operation.
      36. The system of Specific Example 35, wherein:
the memory stores a set of pre-twiddle factors associated with the NTT operation and a set of butterfly twiddle factors associated with the NTT operation; and
the set of pre-twiddle factors comprises the set of butterfly twiddle factors.
   37. The system of any one of Specific Examples 31-36, wherein the permutation processing element performs XOR-based permutations of the form (i×a+b)⊕c, wherein i is an input data index, a is an odd integer, and b and c are integers.
   38. The system of Specific Example 37, wherein:
the permutation processing element receives the first data in a CTB ordering; and
the NTT receives the transformed first data in a natural ordering.
   39. The system of any one of Specific Examples 31-38, wherein:
the MAC unit receives the transformed first data from the permutation engine; and
the MAC unit performs a key switching operation on the transformed first data.
   40. A device for executing programs and processing data that have been homomorphically encrypted, the device comprising:
an interface to a host system board;
a mass memory;
a high-speed bus interconnect coupled to the mass memory and the interface; and
a dedicated fully homomorphic encryption accelerator comprising a multiply-accumulate unit and a number theoretic transform (NTT) unit; wherein the dedicated fully homomorphic encryption accelerator is communicatively coupled to the mass memory, the high-speed bus interconnect, and the interface;
wherein:
   the interface:
      receives encrypted input data to be stored in the mass memory; and
      sends encrypted output data from the mass memory to the processing board; and
   the dedicated fully homomorphic encryption accelerator:
      reads the encrypted input data from the mass memory;
      at the multiply-accumulate unit, generates a sequence of powers of a set of seed values; and
      generates the encrypted output data, comprising, at the NTT unit, performing NTT operations on the encrypted input data using the sequence of powers.
         41. A method for conflict-free memory accesses, the method comprising: storing data in a single-port memory, wherein:
the memory can be accessed by row or column; and
the data is arranged in a scrambled ordering;
defining a bank as a specified row exclusive or-ed with a specific column;
when addressing a row, mapping a bank i to an index i xor the row; and
when addressing a column, mapping a bank i to an index i xor the column.
   42. The method of Specific Example 41, further comprising:
using permutation processing elements to reorder the data from the memory.
   43. The method of Specific Example 42, wherein the memory is accessed via a single-cycle operation per chunk, wherein a chunk is defined as a number of coefficients to be accessed per cycle.
   44. The method of Specific Example 43, wherein using permutation processing elements to reorder the data from the memory comprises:
when addressing a row, a chunk of data is received from the columns.
   45. The method of Specific Example 43 or 44, wherein using permutation processing elements to reorder the data from the memory comprises:
when addressing a column, a chunk of data is received from the rows.
   46. The method of any one of Specific Examples 42-45, wherein:
the permutation processing elements includes a network of conditional step nodes, wherein the number of conditional step nodes is related to a size of the permutation processing element.
   47. The method of any one of Specific Examples 42-46, wherein:
the permutation processing elements includes a network of conditional step nodes, where the conditional swap nodes either swap inputs or keep the inputs the same based on a control value.
   48. The method of any one of Specific Examples 41-47, wherein an address bit determines whether the memory is to be accessed to address a row or column.

All references cited herein are incorporated by reference in their entirety, except to the extent that the incorporated material is inconsistent with the express disclosure herein, in which case the language in this disclosure controls.

As used herein, “substantially” or other words of approximation can be within a predetermined error threshold or tolerance of a metric, component, or other reference, and/or be otherwise interpreted.

Optional elements, which can be included in some variants but not others, are indicated in broken line in the figures. However, unbroken lines in the figures should not be interpreted to indicate that the depicted elements are essential, nor to indicate that the depicted elements may not be omitted from variants of the invention.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A system for processing homomorphically encrypted data, the system comprising:
a memory that stores encrypted data;
a first multiply-accumulate (MAC) unit communicatively coupled to the memory, wherein the first MAC unit generates modified encrypted data by performing a modular arithmetic operation on the encrypted data based on a prime modulus parameter value;
a random number generator that generates a first portion of a key switching key using a programmable seed value and the prime modulus parameter value; and
a second MAC unit communicatively coupled to the random number generator and to the first MAC unit, wherein the second MAC unit:
receives the first portion of the key switching key from the random number generator;
receives the modified encrypted data from the first multiply-accumulate unit;
determines a second portion of the key switching key; and
performs a key switching operation on the modified encrypted data based on the first and second portions of the key switching key.

2. The system of claim 1, wherein the second multiply-accumulate unit comprises:
a register file;
a plurality of multiplexers, wherein a first multiplexer of the plurality of multiplexers is communicatively coupled to the register file; and
a plurality of multipliers, wherein each multiplier of the plurality of multipliers is communicatively coupled to a respective multiplexer of the plurality of multiplexers.

3. The system of claim 2, wherein performing the key switching operation on the modified encrypted data comprises:
generating an intermediate value, comprising performing a first multiplication operation;
storing the intermediate value in the register file;
after storing the intermediate value, retrieving the intermediate value from the register file; and
performing a second multiplication operation on the intermediate value retrieved from the register file.

4. The system of claim 3, wherein retrieving the intermediate value from the register file comprises, at the first multiplexer:
selecting the register file as a selected source;
receiving the intermediate value from the register file; and
based on selecting the register file as the second selected source, providing the intermediate value to a first input of a first multiplier of the plurality.

5. The system of claim 4, wherein generating the intermediate value further comprises:
at a second multiplexer of the plurality:
selecting a second selected source from the group consisting of: the register file and an input port of the second MAC;
receiving selected data from the selected source; and
providing the selected data to a second input of the first multiplier;
at the first multiplier, computing a first product by performing the first multiplication operation, wherein the first multiplication operation is performed using the selected data as a factor; and
determining the intermediate value based on the first product.

6. The system of claim 5, wherein:
generating the intermediate value further comprises, at the first multiplexer, providing a second factor to the first input of the first multiplier, wherein the first multiplication operation is performed further using the second factor, wherein the first product is equal to the product of the selected data and the second factor; and
determining the intermediate value based on the first product comprises:
at the first multiplier, providing the first product to a third multiplexer;
at the third multiplexer, providing the first product to an adder of the second MAC; and
at the adder, computing the intermediate value using the first product.

7. The system of claim 1, wherein determining the second portion of the key switching key comprises, at the second MAC unit, generating the second portion of the key switching key using the first portion.

8. The system of claim 1, wherein determining the second portion of the key switching key comprises, at the second MAC unit, receiving the second portion from the memory.

9. The system of claim 1, wherein:
the random number generator comprises a plurality of generator units;
generating the first portion of the key switching key is performed using a plurality of seed values comprising the programmable seed value, wherein each seed value of the plurality is associated with a different generator unit of the plurality; and
generating the first portion of the key switching key comprises, for each generator unit of the plurality: generating a respective sub-portion of the first portion of the key switching key using the associated seed value of the plurality.

10. The system of claim 9, wherein:
the prime modulus parameter value defines a ring of integers reduced modulo the prime modulus parameter value; and
the seed values of the plurality are evenly distributed across the ring.

11. A method for processing homomorphically encrypted data, the method comprising:
receiving encrypted data;
generating modified encrypted data based on the encrypted data, comprising, at a multiply-accumulate (MAC) unit, based on a prime modulus parameter value, performing a modular arithmetic operation on the encrypted data; and
after performing the modular arithmetic operation, performing a key switching operation on the modified encrypted data, wherein performing the key switching operation comprises:
at a random number generator, generating a first portion of a key switching key using: a generator value, the prime modulus parameter value, and a plurality of programmable seed values equally spaced throughout a generation period; and
at the MAC unit:
receiving the first portion of the key switching key;
determining a second portion of the key switching key; and
transforming the modified encrypted data using the first and second portions of the key switching key.

12. The method of claim 11, wherein performing the key switching operation on the modified encrypted data further comprises, at the MAC unit:
generating an intermediate value, comprising performing a first multiplication operation;
storing the intermediate value in a register file of the MAC unit;
after storing the intermediate value, retrieving the intermediate value from the register file; and
after retrieving the intermediate value from the register file, performing a second multiplication operation on the intermediate value.

13. The method of claim 12, wherein:
performing the key switching operation on the modified encrypted data further comprises, at the MAC unit, receiving a constant weight value via an immediate value input; and
performing the second multiplication operation comprises computing a weighted sum by multiplying the intermediate value with the constant weight value.

14. The method of claim 11, wherein determining the second portion of the key switching key comprises receiving the second portion of the key switching key from a memory.

15. The method of claim 11, wherein determining the second portion of the key switching key comprises generating the second portion of the key switching key based on the first portion of the key switching key.

16. The method of claim 11, wherein the generation period is a ring of integers reduced modulo the prime modulus parameter value.

17. The method of claim 11, wherein transforming the modified encrypted data using the first and second portions of the key switching key further comprises performing a second plurality of modular arithmetic operations on the modified encrypted data.

18. The method of claim 11, wherein the encrypted data is received from a memory unit.

19. The method of claim 18, further comprising, at the random number generator, receiving the plurality of programmable seed values, the generator value, and the prime modulus parameter value from the memory unit.

20. The method of claim 11, wherein performing the key switching operation further comprises generating the key switching key by appending the second portion of the key switching key to the first portion of the key switching key.
